(19) United States
(12) Patent Application Publication
(10) Pub. No.: US 2005/0200114 A1
(43) Pub. Date: Sep. 15, 2005

(54) Seatbelt-activated actuator system and device

(76) Inventors: Edward H. Arnold JR., Arroyo Grande, CA (US); Lonny MacDougall, Phoenix, AZ (US)

Correspondence Address: Steven Thrasher, 391 Sandhill Dr., Richardson, TX, 75080, US

(21) Appl. No.: 10/796,641

(22) Filed: Mar. 9, 2004

(51) Int. Cl. B60R 22/00

(52) U.S. Cl. 280/801.1

(57) ABSTRACT

The invention is a system and device that enables a seatbelt to provide functionality other than seatbelt fastening.

### TECHNICAL FIELD

The invention relates to motor vehicles, and, more particularly, the invention relates to seatbelts for motor vehicles.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Seatbelts are nearly universally required in motor vehicles. The sole purpose for having seatbelts in motor vehicles is to provide occupant safety. Accordingly, seatbelts are credited with saving thousands of life and reducing injury in thousands of motor vehicle accidents each year. In fact when an accident occurs frequently the first thought of an occupant is the status of their seatbelt. However, seatbelts cannot do it all.

For example, persons may become trapped in a vehicle due to a wide variety of circumstances. Sometimes, due to poor driving or to poor road conditions, a person may drive a car into a body of water, such as a reservoir, lake, or flooded street, thereby trapping the occupants of the vehicle inside. In yet other circumstances a vehicle occupant may be trapped inside a car as a result of an accident. Occasionally, vehicles catch fire due to electrical problems or as a result of accidents and burn any occupants who are trapped inside. Whether due to fire, flood, or other trapping, vehicle occupants need a means for escape in the event they are trapped inside and face potential danger. Accordingly, there is a need for inventive systems and devices that enable an occupant to have more control over an escape from a motor vehicle. The present invention provides such a system and device.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a seatbelt actuator system;

FIG. 2 illustrates a seatbelt plate; and

FIG. 3 is a block diagram of a seatbelt actuator receptacle.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. The invention is also described in view of the Festo decisions, and, in that regard, the claims and the invention incorporate equivalents known, foreseeable, and unforeseeable.

Discussion of the Figures

Accordingly, the invention can be characterized as systems, methods, and devices that allow a user to employ a seatbelt to initiate some other function. Desired seat-belt initiated functions include safety/lifesaving functions, such as window shattering, summoning an emergency vehicle or emergency services, electrical system cut-off, or door detachment, for example. The invention uses a receptacle that identifies a seatbelt, which may be a modified seatbelt, and, upon the identification, initiates a secondary function, often via an actuator. In a preferred embodiment, the actuator dislodges a side door from the vehicle's frame. Accordingly, as motor vehicle occupants often first think of a seatbelt at and following the moment of impact, they will, by removing it, already be on the path to taking the next steps to insure their survival and safety in an accident.

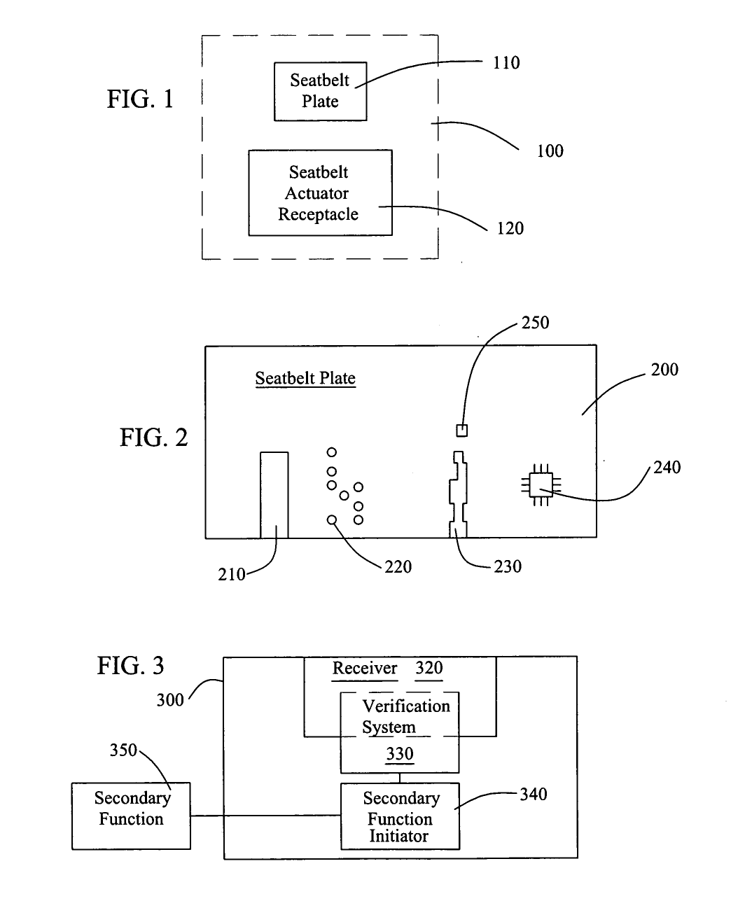

Features and advantages of the invention can be better understood by reviewing FIG. 1, which illustrates a seatbelt actuator system 100. The seatbelt actuator system 100 generally comprises a seatbelt plate 110 and a seatbelt actuator receptacle (the “seatbelt receptacle”, or “the receptacle”) 120. The seatbelt plate 110 preferably has the appearance and provides the locking function of prior art seatbelt—in other words, the seatbelt plate 110 may lock into a prior art seatbelt receptacle to secure a seatbelt about an occupant of a motor vehicle because it is adapted to securely fasten to a seatbelt receptacle 120. In addition, the seatbelt plate 110 enables the receptacle 120 to initiate a secondary function.

Accordingly, the receptacle 120 receives a seatbelt plate 110 and initiates a secondary function. The receptacle 120 may take the appearance of a prior art seatbelt receptacle, or may take the appearance of a slot, slit, or sliding scanner for example. Accordingly, it should be understood that the receptacle 120 is not limited by structural implementation, but rather by function. In addition, the secondary function may be initiated in one embodiment by displacing an internal switch, “tripping” a switch, or, alternatively, via an engagement such as the engagement that occurs when a standard seat-belt plate “locks” with a receptacle 120.

FIG. 2 illustrates a seatbelt plate 200 adapted to fasten as a first function, and further adapted to initiate a second function when it is mated with a receptacle 120. The seatbelt plate 200 may include one or more identifiers that allow a receptacle 120 to detect that the seatbelt plate 200 has been mated with the receptacle 120. For example, a magnetic strip 210, a sequence of holes 220, a sequence of cuts 230, a computer chip 240, a sensor 250, or a hologram may be incorporated upon the seatbelt plate 200 so that it can be paired with or may be uniquely identified by the seatbelt actuator receptacle 120. Of course, it should be understood that additional identifiers are known, foreseeable, and unforeseeable, and each of these may also be incorporated in the invention without departing from the scope of the invention, and are incorporated herein. Further, the seatbelt plate 200 may incorporate a single identifier, or a plurality of identifiers as illustrated in FIG. 2.

FIG. 3 is a block diagram of a receptacle 300, which is configured to accept and identify the seatbelt plate 200. In general, the actuator receptacle is adapted to initiate a second function other than the fastening of a seatbelt. The receptacle 300 comprises a seatbelt plate receiver (the receiver) 320, and a seatbelt plate verification system 330 that is preferably mechanically or electrically coupled to a secondary function initiator (the initiator) 340. In addition, the receptacle 300 includes a secondary system 350 coupled to a secondary function initiator 340, where the secondary system 350 is not a locking function.

The receiver 320 is mechanically configured to mate with the seatbelt plate 200. In a preferred embodiment the receiver 320 holds or secures the seatbelt plate 200 into the receptacle 300, and also preferably orients the seatbelt plate 200 so that an identifier is aligned with the verification system 330 when a seatbelt plate 200 is in the receiver 320. The verification system 330 generally includes an identifier reading means (not shown) that is adapted to read an identifier on a seatbelt plate.

Accordingly, the verification system 330 comprises an identifier reading means such as a magnetic strip reader, a punch-hole-space identifier (such as is used in hotel locks), a key reader, an infrared or radio wave detector, or an electrical pin collector for example. Further, the verification system includes the intelligence, and processing components needed to convert a detected identifier into a predetermined electric output. The secondary function initiator 340 converts a mechanical electrical signal received in the verification system 330 and converts it into a signal receivable by the secondary function 350, which may in turn produce an electrical or wireless signal.

The secondary system 350 provides a function other than the locking/unlocking seatbelt about a motor vehicle occupant. In general, preferred secondary systems are electromechanical systems, and are implemented with actuators, wireless receivers or the like. In one preferred embodiment, the secondary system is a window dicing system coupled to the secondary function initiator. Similarly, an alternative secondary system is a window pop-out system that is particularly desirable for removing unbreakable windows, or windows reinforced with wires, in emergency situations. One such system is disclosed in co-pending, co-owned and co-authored U.S. Pat. No. ______. Other secondary systems include door-dislodging systems, fire retardant systems that may dispense fire-suppressing material, a flotation system to keep a vehicle from sinking, or a power shut-off system that kills power in the motor vehicle, for example.

Some preferred secondary systems are communication systems. For example, one secondary system is a local emergency contact system coupled to the secondary function initiator. This secondary system may use a local cellular or data network in conjunction with a global positioning unit to contact local emergency help via a “911” call or other emergency services system. Alternatively, the secondary system is a remote emergency contact system that communicates via satellite with a third party or emergency services provider. One exemplary third party communication system is the OnStar™ system available from General Motors™.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A seatbelt system adapted to fasten as a first function, and further adapted to initiate a second function, comprising:
a seatbelt plate adapted to securely fasten to a seatbelt receptacle;
the seatbelt plate adapted to mate with a seatbelt receptacle, the seatbelt plate having an identifier;
the seatbelt receptacle configured to accept the seatbelt plate and to identify the identifier; and
the seatbelt receptacle adapted to initiate a second function other than the fastening of a seatbelt.

2. The system of claim 1 wherein the second function is an electromechanical function.

3. The system of claim 1 wherein the seatbelt plate comprises a magnetic strip for adapting the seatbelt plate to pair with the actuator receptacle.

4. The system of claim 1 wherein the seatbelt plate comprises a sequence of cuts for adapting the seatbelt plate to pair with the actuator receptacle.

5. The system of claim 1 wherein the seatbelt plate comprises a sequence of holes for adapting the seatbelt plate to pair with the actuator receptacle.

6. The system of claim 1 wherein the seatbelt plate comprises a computer chip for adapting the seatbelt plate to pair with the actuator receptacle.

7. The system of claim 1 wherein the seatbelt plate comprises a sensor for adapting the seatbelt plate to pair with the actuator receptacle.

8. A seatbelt actuator receptacle, comprising:
a seatbelt plate receiver;
a verification system; and
a secondary function initiator in communication with a secondary function and coupled to the verification system, where the secondary function is not a fastening of a seatbelt.

9. The actuator receptacle of claim 8 wherein the verification system electrically couples to a secondary function initiator.

10. The actuator receptacle of claim 8 wherein the secondary function system is a window dicing system coupled to the secondary function initiator.

11. The actuator receptacle of claim 8 wherein the secondary system is a window pop-out system coupled to the secondary function initiator.

12. The actuator receptacle of claim 8 wherein the secondary system is a door dislodging system coupled to the secondary function initiator.

13. The actuator receptacle of claim 8 wherein the secondary system is a local emergency contact system coupled to the secondary function initiator.

14. The actuator receptacle of claim 8 wherein the secondary system is a remote emergency contact system coupled to the secondary function initiator.

15. The actuator receptacle of claim 8 wherein the secondary system is a fire retardant system coupled to the secondary function initiator.

16. The actuator receptacle of claim 8 wherein the secondary system is a power shut-off system coupled to the secondary function initiator.

17. The actuator receptacle of claim 8 wherein the secondary system is a flotation system coupled to the secondary function initiator.
